(19) United States
(12) Patent Application Publication
(10) Pub. No.: US 2010/0333016 A1
(43) Pub. Date: Dec. 30, 2010

(54) SCROLLBAR

(75) Inventor: Iwan Anthony Attwood, Surrey (GB)

Correspondence Address: Perman & Green, LLP, 99 Hawley Lane, Stratford, CT, 06614, US

(73) Assignee: NOKIA CORPORATION, Espoo (FI)

(21) Appl. No.: 12/494,504

(22) Filed: Jun. 30, 2009

(51) Int. Cl. G06F 3/048

(52) U.S. Cl. 715/784; 715/856

(57) ABSTRACT

A method, apparatus, user interface and computer program product for providing a display window with a perimeter, displaying a set of data in a display area of the display window, the set of data having zero or more elements, providing at least one scroll region on the display, wherein movement of a pointing device in the at least one scroll region causes the set of data in the display area to be scrolled in a corresponding direction according to a scroll increment; and responsive to a repositioning of the pointing device in a manner that deflects the pointing device away from an axis path of the scroll region, increasing an available scrolling distance in the display window.

### BACKGROUND

1. Field

The aspects of the disclosed embodiments generally relate to navigation of information on displays and in particular to navigating documents using a scroll device.

2. Brief Description of Related Developments

A scrollbar presents a position along a single axis on a display of a device, such as a mobile communication device. When the scrollbar is used to represent a long document there comes a point where the position of the scrollbar thumb can not resolve the exact position in the document. As this point approaches it becomes much harder for a user to accurately position the thumb as very small movements in the thumb cause large jumps in the represented document. For desktop operating systems the use of a mouse allows this effect to be reduced to, for example, a one pixel limit. Using a scroll wheel on a mouse can limit the effect to one line at a time. For high resolution touch screen displays there is an additional limit imposed by the digitizer, which must be able to resolve position to a single pixel mapping on the display to be as effective as mouse input. The problem is further increased by the use of finger inputs or control, which generally result in a large contact area, making absolute position hard to control and determine. In such cases, the scrollbar becomes ineffective as an input method for positioning a document on a touch screen device.

Existing approaches to this problem have evolved around removing the scrollbar paradigm from the user interface. Examples of this include direct dragging of a document where the page is moved only as far as the screen size, resulting in very slow navigation through a document. To counter the speed issue of direct dragging, kinetic scrolling has been used. By giving the page “weight”, users can apply speed to the direct scrolling. Releasing the stylus allows the document to continue scrolling at the speed of the gesture. Kinetic scrolling leads to very imprecise scrolling at speeds that require the user to apply corrections for the page to be positioned accurately. In addition to kinetic scrolling, indexing tabs may also be used to allow large jumps though a document before fine positioning of the page is achieved through direct dragging.

It would be advantageous to be able to provide a smooth transition from rapid navigation of a document to fine position while using a scrollbar. Accordingly, it would be desirable to provide a system that addresses at least some of the problems identified above.

### SUMMARY

The aspects of the disclosed embodiments are directed to at least a method, apparatus, user interface and computer program product. In one embodiment the method includes providing a display window with a perimeter, displaying a set of data in a display area of the display window, the set of data having zero or more elements, providing at least one scroll region on the display, wherein movement of a pointing device in the at least one scroll region causes the set of data in the display area to be scrolled in a corresponding direction according to a scroll increment; and responsive to a repositioning of the pointing device in a manner that deflects the pointing device away from an axis path of the scroll region, increasing an available scrolling distance in the display window.

### BRIEF DESCRIPTION OF THE DRAWINGS

The foregoing aspects and other features of the embodiments are explained in the following description, taken in connection with the accompanying drawings, wherein:

FIG. 1 is a block diagram of a system incorporating aspects of the disclosed embodiments;

FIG. 2A-2C illustrate aspects of exemplary scrollbars;

FIG. 3 illustrates an exemplary scrollbar incorporating aspects of the disclosed embodiments;

FIG. 4A-4B are illustrations of exemplary devices that can be used to practice aspects of the disclosed embodiments;

FIG. 5 illustrates a block diagram of an exemplary system incorporating features that may be used to practice aspects of the disclosed embodiments; and

FIG. 6 is a block diagram illustrating the general architecture of an exemplary system in which the devices of FIGS. 4A and 4B may be used.

### DETAILED DESCRIPTION OF THE EMBODIMENT(S)

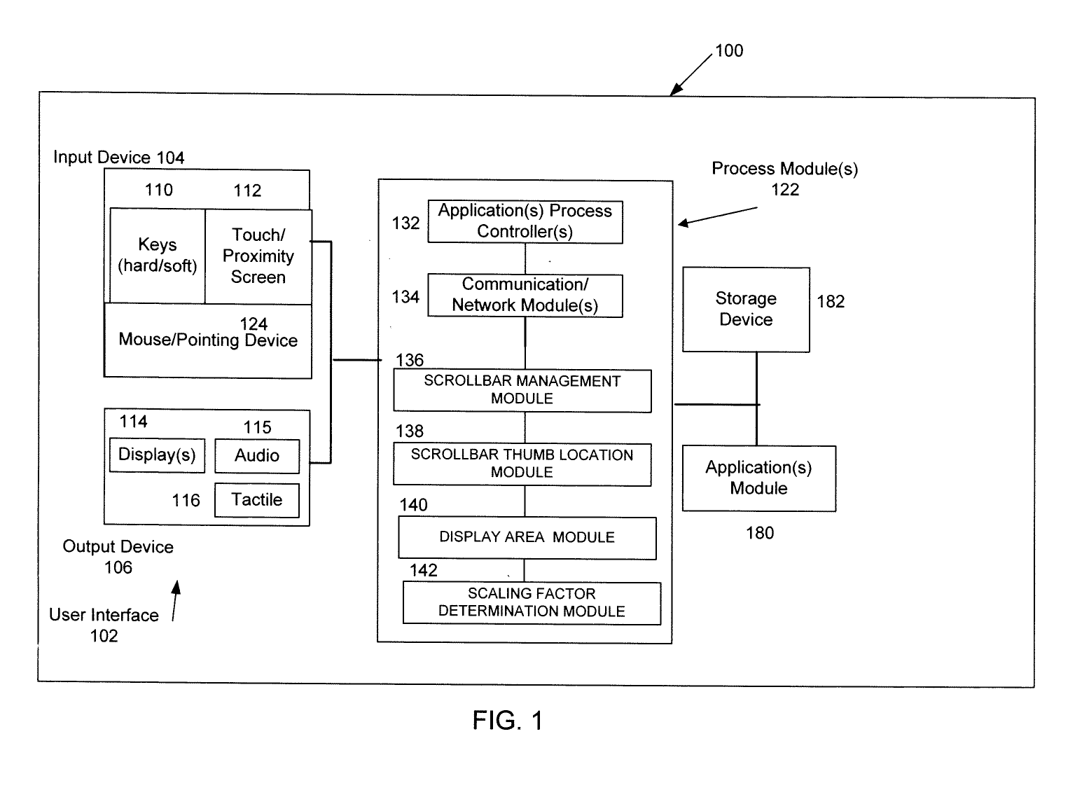

FIG. 1 illustrates one embodiment of a system 100 in which aspects of the disclosed embodiments can be applied. Although the disclosed embodiments will be described with reference to the embodiments shown in the drawings and described below, it should be understood that these could be embodied in many alternate forms. In addition, any suitable size, shape or type of elements or materials could be used.

The aspects of the disclosed embodiments generally provide for transitioning from rapid navigation of a document to fine positioning of the document, using a scroll region or area, such as for example a scrollbar, as a navigation tool. Although the aspects of the disclosed embodiments will generally be described with respect to a scrollbar, this is for exemplary purposes only. The scope of the disclosed embodiment are generally intended to encompass any suitable scroll device, such as for example, a touch sensitive scroll region on or in conjunction with a display. For example, certain computer laptop devices include a defined touch sensitive area that is used to control movement of a cursor on the display, or the movement or scrolling of information presented on the display of the laptop. Alternatively, in some devices, all or a portion of the display area is touch sensitive and is configured to allow the control of the viewing and movement of information on or about the display.

The aspects of the disclosed embodiments will increase a granularity of a scroll increment when movement of a pointing device away from an approximate center line of the scroll area is detected. When using a device with a scroll area, moving of the pointing device in one direction, such as from top to bottom, bottom to top, or side to side, will generally cause a corresponding movement of the information being displayed. Generally, the movement of the pointing device is in an approximate straight line, or an axis path. The aspects of the disclosed embodiments will detect when the movement of the pointing device is a away from the axis path, or the approximate straight line that can be defined using the initial starting point, or contact point of the pointing device with the scroll area. For example, in one embodiment, when the pointing device makes contact with the scroll region, an approximate straight line is defined. The line, referred to herein as the axis path, can be defined from top to bottom, bottom to top, and side to side of the scroll area. As the pointing device is moved, the information being displayed will move correspondingly. If the pointing device moves away from the axis path, in any direction, the scroll increment will be adjusted to decrease the scroll increment, effectively increasing the scroll area. Thus, more of the information will be able to viewed on the display.

In one embodiment, when the scroll area is a scrollbar, as that term is generally understood, a thumb of a scrollbar is configured to be dragged out of the axis path of a scrollbar. The degree of deflection of the thumb from the axis path allows calculation of a scaling factor that can be used to slow the scrolling for fine positioning.

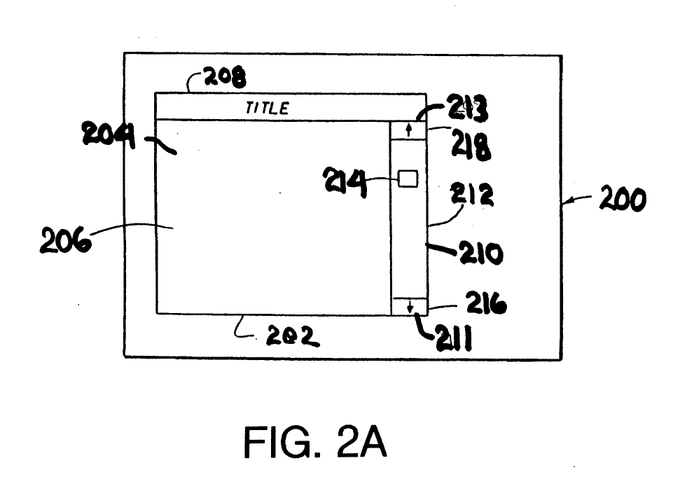

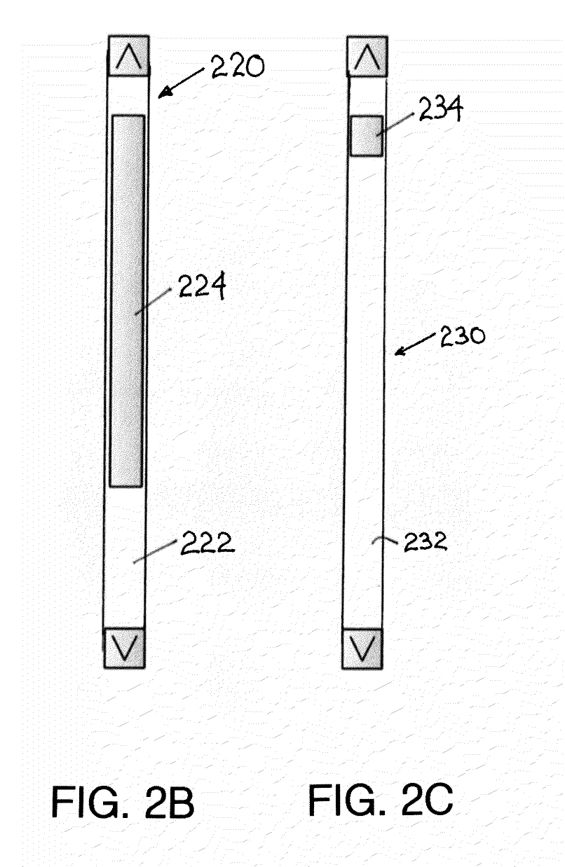

As shown in FIG. 2A, a user interface 200 generally employs a display window or page 202. In one embodiment, the window 202 displays a set of data 204, also referred to as application presentation space, in a display area 206. The information or set of data 204 displayed within the display area 206 can be composed of any suitable data or information, such as for example, but not limited to, images, files, icons, documents, web pages or applications.

As shown in FIG. 2A, the window 202 is generally rectangular in configuration. In alternate embodiments, the window 202 can be any suitable configuration. When displayed, the window 202 can be provided with an identifying title block 208, it being understood that an arbitrary number of windows can be displayed at any one time. In order to be effectively employed, the window 202 must be capable of being moved, scrolled, in either a vertical and/or horizontal direction within the display area 206. The scrollbar 210 is a known structure that can be used to control and visualize the movement of the window 202 over the display area 206 and is generally positioned along a perimeter of the window 202 in any suitable or convenient orientation. Although the aspects of the disclosed embodiments generally show a scrollbar that is visible, in alternate embodiments, the scroll region or scrollbar does not have to be visible.

The scrollbar 210 is often used in conjunction with a pointing device, such as for example, a mouse, trackball, or the user's finger. As shown in FIG. 2A, the scrollbar 210 has a first end 211 and a second end 213, and a thumb 214 positioned between the first end 211 and the second end 213. When the window 202 is too small in either the horizontal or vertical direction for the information, data or content 204 that is too be presented, relative to the dimensions of the display area 206, the scrollbar 210 is presented and allows navigation, or scrolling, of the presented information 204. As shown in FIG. 2A, the scrollbar 210 is vertically disposed. In alternate embodiments, the scrollbar 210 can be horizontally disposed. In other embodiments, a scrollbar 210 can be provided on each of the vertical and horizontal axis.

The generally comprises a track 212, and a thumb 214, also referred to as a bubble or slider, among other things. The thumb 214 is moved along the corresponding axis of the track 212 in either of the directions indicated by the direction indicator blocks 216 and 218, also referred to as “block increment” indicators. As the thumb 214 is moved in the desired direction, the relative position of the window 202 on the display area 206 is moved accordingly.

FIG. 2B illustrates an example of a scrollbar 220 where the thumb 224 in the track 222 has a size that is proportional to a page length of the window 202. In this situation, it is possible to determine an absolute position with the page or window 202. FIG. 2C illustrates the situation where the thumb 234 is at a minimum size and is no longer proportional to the length of the page or window 202. The length of the scrollbar 200 is incapable of representing the page 202, causing erratic scrolling as the digitizer can no longer track position within the page 202 accurately. The scrollbar 234 is too short accurately represent the length of the page 202.

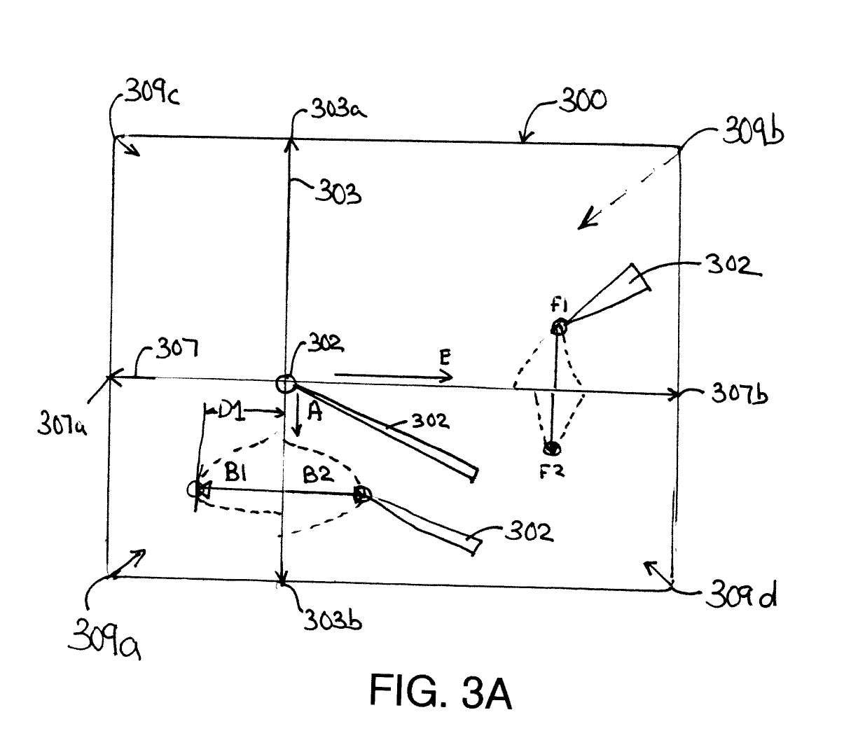

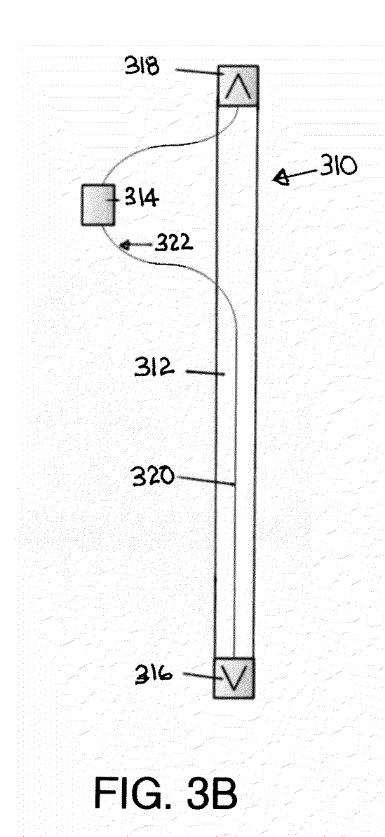

FIG. 3A illustrates an example of a touch sensitive scroll area 300 incorporating aspects of the disclosed embodiments. A pointing device 301 makes an initial contact with the scroll area 300 at point 302, which can be any point or position on the scroll area 300. A virtual line or axis path 303 can be defined from top 303a to bottom 303b of the scroll area 300. An initial movement of the pointing device 302 in the direction A will cause the information or data presented on the display area of the device to move correspondingly. In one embodiment, the scroll area 300 comprises the display area of the device.

If the pointing device 301 is then moved in either of the directions B1 or B2, the line 303 can virtually “deflect” away from its original axis path between the top point 303a and the bottom point 303b. The distance D1 is used to define the increase in granularity of the scroll increment.

Similarly, virtual line or axis path 307 is defined between points 307a and 307b. If the pointing device is initially moved in direction E, the information or data will move accordingly. The subsequent movement of the pointing device in either of directions F1 or F2, the scroll increment will be redefined to provide increased viewing of the information or data.

The axis paths 303 and 307 are merely exemplary, are not limited to the X-Y directions, and can include axis paths extending in the Z-axis, for example from points 309a to 309b and 309c to 309d, or between any two points along each of the edges of the scroll region 300.

Referring to FIG. 3B, in one embodiment, a scrollbar 310 includes a thumb 314 that is configured to be “dragged” or moved out of the track 312, and thereby increase the available scrolling distance. As shown in FIG. 3, the thumb 314 is moved out of the line 320 of the track 312, also referred to as an amount of deflection 322. In one embodiment, a scalar is applied based on a distance the thumb 314 has been dragged out of the line of the track 312 to redefine the distance shifted in the page to each increment of scroll represented by the digitizer. This can allow the user to easily set the granularity at which the page is scrolled, allowing for fast and accurate positioning. In one embodiment, the scalar can be applied in a logarithmic fashion to the deflection of the thumb 314 from the line of the track 312. Small deflections from the line 320 of the track 312 can cause little change in the scaling applied. Larger deflections can cause more refined scaling. In one embodiment, relapsing the thumb 314 from the deflected position can cause the thumb 314 to “snap” back to it approximate position in the unscaled scrollbar, such as shown in FIG. 2B. This can be caused by removing the pointing device from the thumb 314.

For example, in a media player, the scrollbar is typically defined by a large, time-based bar, where large time increments, such as hours, can be quickly scrolled. By being able to deflect the position of the thumb 314 from the line of the track 312, a time based scalar can be redefined to minutes, or even seconds, depending upon the amount of the deflection.

Generally, the system 100 of FIG. 1 includes at least one user interface 106, process modules 122, applications module 180, and storage devices 182. In alternate embodiments, the system 100 can include other suitable systems, devices and components that allow for transitioning from rapid navigation of a document to fine positioning of the document, using a scrollbar as a navigation tool. The components described herein are merely exemplary and are not intended to encompass all components that can be included in the system 100. The devices described with respect to the system 100 can also include one or more processors or computer program products to execute the processes, methods, sequences, algorithms and instructions described herein.

The user interface 106 generally comprises one or more input devices 104 and output devices 106. The input device(s) 104 are generally configured to allow the input of data, instructions, information gestures and commands to the system 100, including movement of the thumb 314 of scrollbar 310. The input devices 104 can include devices such as, for example but not limited to, keys or keypad 210, touch sensitive area or proximity screen 112 and a mouse or pointing device 124. In one embodiment, the keypad 110 can be a soft key or other such adaptive or dynamic device of a touch screen 112. The input device 104 can also be configured to receive input commands remotely or from another device that is not local to the system 100. The input device 104 can also include camera devices (not shown) or other such image capturing system(s). In alternate embodiments the input device 104 can comprise any suitable device(s) or means that allows or provides for the input and capture of data, information and/or instructions to a device, as described herein.

The output device(s) 106 are generally configured to allow information and data to be presented to the user via the user interface 102 of the system 100 and can include one or more devices such as, for example, a display 114, audio device 115 and/or tactile output device 116. In one embodiment, the output device 106 can also be configured to transmit information to another device, which can be remote from the system 100. While the input device 104 and output device 106 are shown as separate devices, in one embodiment, the input device 104 and output device 106 can comprise a single device, such as for example a touch screen device, and be part of and form, the user interface 102. For example, in one embodiment where the user interface 102 includes a touch screen device, the touch sensitive screen or area 112 can also provide and display information, such as keypad or keypad elements and/or character outputs in the touch sensitive area of the display 114. While certain devices are shown in FIG. 1, the scope of the disclosed embodiments is not limited by any one or more of these devices, and an exemplary embodiment can include, or exclude, one or more devices.

The process module 122 is generally configured to execute the processes and methods of the disclosed embodiments. As described herein, the process module 122 is generally configured to allow for transitioning from rapid navigation of a document to fine positioning of the document, using a scrollbar as a navigation tool. In one embodiment, the process module 122 includes a scrollbar management module 136, a scrollbar location module 138, and a display area module 140 and a scale factor module 142. In alternate embodiments, the process module 122 can include any suitable function or application modules that provide for transitioning from rapid navigation of a document to fine positioning of the document, using a scrollbar as a navigation tool, as is further described herein.

In one embodiment, the scrollbar management module 136 is configured to provide the scrollbar 210 as shown in FIG. 2, together with the thumb 214 and indicators 216 and 218. The scrollbar location module 138 is generally configured to configure the thumb 214 of the scrollbar 210 in conjunction with the display area module 140. The display area module 140 is generally configured to determine, manage and present the information 204 in the display area 206 as well as allow the information to be scrolled as described herein, in conjunction with the scrollbar management module 136 and scrollbar location module 138.

The scaling factor module 142 is generally configured to providing a scrollbar increment value, depending upon the position of the thumb 214, as determined by the scrollbar management module 136 and scrollbar location module 138. When the thumb 214 is within the axis path of the track 212, the scrollbar can be considered to be unscaled. When the thumb 214 is deflected, as illustrated in FIG. 3 by thumb 314, the scaling applied is changed, depending upon the degree of deflection. The scaling factor module 142 is configured to apply a scalar based on the distance the thumb is dragged away from the axis path of the track 312. The modified scaling value can be provided to the scrollbar management module 136, which will cause the presentation of the scrollbar 310, and the scrolling of the information, to be modified accordingly. In one embodiment, the scrollbar location module 138 is configured to determine the degree of deflection and distance. In one embodiment, the scaling factor module 142 is configured to define the scalar in a logarithmic fashion, where small deflections result in small changes in scaling, while larger deflections result in larger scaling changes. Larger scaling changes generally result in greater refinement of the scrolling of the information.

Each of the scrollbar management module 136, the scrollbar location module 138, display area module 140 and scale factor module 142 are configured to receive and transmit information to and between each other and each of the other devices, module and components of the system 100. Each module can include its own processor(s) and computer readable storage medium for carrying out and executing the processes described herein.

The application process controller 132 shown in FIG. 1 is generally configured to interface with the applications module 180 and execute applications processes with respects to the other modules of the system 100. In one embodiment the applications module 180 is configured to interface with applications that are stored either locally to or remote from the system 100 and/or web-based applications. The applications module 180 can include any one of a variety of applications that may be installed, configured or accessible by the system 100, such as for example, office, business, media players and multimedia applications, web browsers, global positioning applications, navigation and position systems and locations and map applications. In alternate embodiments, the applications module 180 can include any suitable application that can be used by or utilized in the processes described herein. For example, in one embodiment, the applications module 180 can interface with a media player application. A media player application can have time based scrollbars associated therewith. The processes described herein will allow the time increment represented by the scrollbar associated with the media player to be refined by detecting and determining an amount of deflection a thumb of the media player scrollbar.

The communication module 134 shown in FIG. 1 is generally configured to allow the device to receive and send communications and messages, such as location and position data, navigation information, text messages, chat messages, multimedia messages, video and email, for example. The communications module 134 is also configured to receive information, data and communications from other devices and systems or networks, such as for example, the Internet. In one embodiment, the communications module 134 is configured to interface with, and establish communications connections with other services and applications using the Internet.

In one embodiment, the applications module 180 can also include a voice recognition system that includes a text-to-speech module that allows the user to receive and input voice commands, prompts and instructions, through a suitable audio input device.

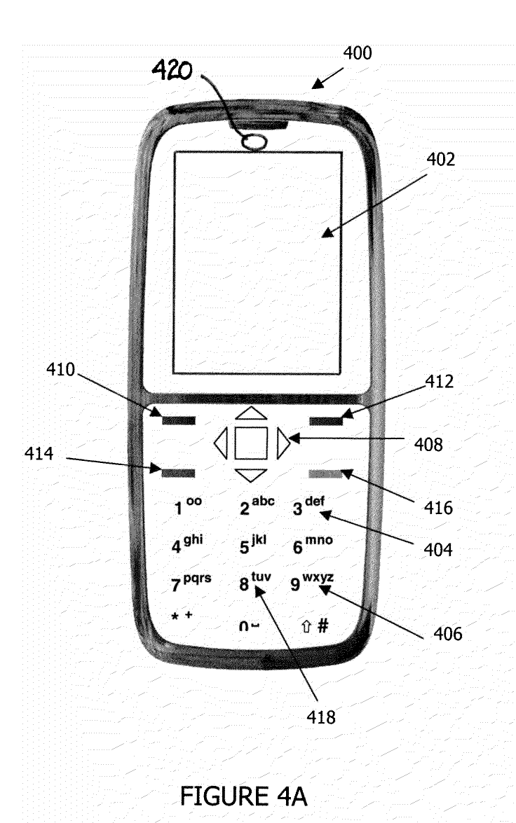

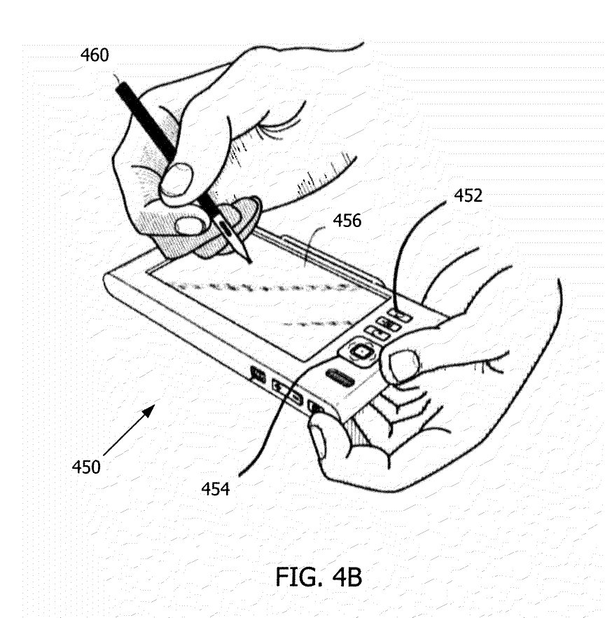

Some examples of devices on which aspects of the disclosed embodiments can be practiced are illustrated with respect to FIGS. 4A-4B. The devices are merely exemplary and are not intended to encompass all possible devices or all aspects of devices on which the disclosed embodiments can be practiced. The aspects of the disclosed embodiments can rely on very basic capabilities of devices and their user interface. Buttons or key inputs can be used for selecting the various selection criteria and links, and a scroll function can be used to move to and select item(s).

FIG. 4A illustrates one example of a device 400 that can be used to practice aspects of the disclosed embodiments. As shown in FIG. 4A, in one embodiment, the device 400 has a display area 402 and a touch sensitive area 404. As noted herein, in one embodiment, the display area 402 can also have touch sensitive characteristics. The user interface and scrollbar device of the disclosed embodiments is generally configured to be implemented on or in a device that includes a touch sensitive area, touch screen display, proximity screen device or other graphical user interface. Although the display 402 of FIG. 4A is shown being integral to the device 400, in alternate embodiments, the display 402 may be a peripheral display connected or coupled to the device 400.

In one embodiment, the touch sensitive area 404 can include keypad 406 as an input device. The keypad 406, in the form of soft keys, may include any suitable user input functions such as, for example, a multi-function/scroll key 408, soft keys 410, 412, call key 414, end key 416 and alphanumeric keys 418. The keypad 406 can also be in the form of the keypad 110 of FIG. 1. In one embodiment, referring to FIG. 4B., the touch screen area 456 of device 450 can also present secondary functions, other than a keypad, using changing graphics.

As shown in FIG. 4B, in one embodiment, a pointing device, such as for example, a stylus 460, pen or simply the user's finger, may be used with the display 456. In alternate embodiments any suitable pointing device may be used. In other alternate embodiments, the display may be any suitable display, such as for example a flat display 456 that is typically made of a liquid crystal display (LCD) with optional back lighting, such as a thin film transistor (TFT) matrix capable of displaying color images.

The terms “select” and “touch” are generally described herein with respect to a touch screen-display. However, in alternate embodiments, the terms are intended to encompass the required user action with respect to other input devices. For example, with respect to a proximity screen device, it is not necessary for the user to make direct contact in order to select an object or other information. Thus, the above noted terms are intended to include that a user only needs to be within the proximity of the device to carry out the desired function.

Similarly, the scope of the intended devices is not limited to single touch or contact devices. Multi-touch devices, where contact by one or more fingers or other pointing devices can navigate on and about the screen, are also intended to be encompassed by the disclosed embodiments. Non-touch devices are also intended to be encompassed by the disclosed embodiments. Non-touch devices include, but are not limited to, devices without touch or proximity screens, where navigation on the display and menus of the various applications is performed through, for example, keys 110 of the system or through voice commands via voice recognition features of the system.

In one embodiment, the device 400 can include an image capture device such as a camera 420 as a further input device. The device 400 may also include other suitable features such as, for example a loud speaker, tactile feedback devices or connectivity port. The mobile communications device may have a processor or other suitable computer program product (not shown) connected or coupled to the display for processing user inputs and displaying information on the display 402 and touch sensitive area 404. A computer readable storage device, such as a memory (not shown) may be connected to the processor for storing any suitable information, data, settings and/or applications associated with the mobile communications device 400.

Although the above embodiments are described as being implemented on and with a mobile communication device, it will be understood that the disclosed embodiments can be practiced on any suitable device incorporating a processor, memory and supporting software or hardware. For example, the disclosed embodiments can be implemented on various types of music, gaming and multimedia devices. In one embodiment, the system 100 of FIG. 1 may be for example, a personal digital assistant (PDA) style device 450 illustrated in FIG. 4B. The personal digital assistant 450 may have a keypad 452, cursor control 454, a touch screen display 456, and a pointing device 460 for use on the touch screen display 456. In one embodiment, the touch screen display 456 can include the QWERTY keypad as discussed herein. In still other alternate embodiments, the device may be a personal computer, a tablet computer, touch pad device, Internet tablet, a laptop or desktop computer, a mobile terminal, a cellular/mobile phone, a multimedia device, a personal communicator, a television set top box, a digital video/versatile disk (DVD) or high definition player or any other suitable device capable of containing for example a display 114 shown in FIG. 1, and supported electronics such as a processor(s) and memory(s) of the device 400 shown in FIG. 4A. In one embodiment, these devices will be Internet enabled and include GPS and map capabilities and functions.

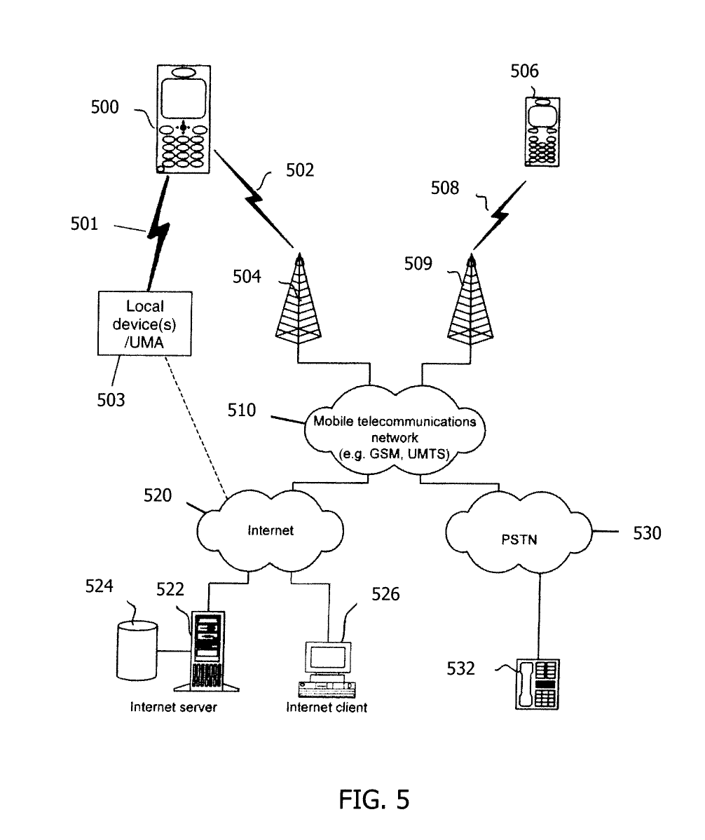

In the embodiment where the device 400 comprises a mobile communications device, the device can be adapted for communication in a telecommunication system, such as that shown in FIG. 5. In such a system, various telecommunications services such as cellular voice calls, worldwide web/wireless application protocol (www/wap) browsing, cellular video calls, data calls, facsimile transmissions, data transmissions, music transmissions, multimedia transmissions, still image transmission, video transmissions, electronic message transmissions and electronic commerce may be performed between the mobile terminal 500 and other devices, such as another mobile terminal 506, a line telephone 532, a personal computer (Internet client) 526 and/or an internet server 522.

It is to be noted that for different embodiments of the mobile device or terminal 500, and in different situations, some of the telecommunications services indicated above may or may not be available. The aspects of the disclosed embodiments are not limited to any particular set of services or communication, protocol or language in this respect.

The mobile terminals 500, 506 may be connected to a mobile telecommunications network 510 through radio frequency (RF) links 502, 508 via base stations 504, 509. The mobile telecommunications network 510 may be in compliance with any commercially available mobile telecommunications standard such as for example the global system for mobile communications (GSM), universal mobile telecommunication system (UMTS), digital advanced mobile phone service (D-AMPS), code division multiple access 2000 (CDMA2000), wideband code division multiple access (WCDMA), wireless local area network (WLAN), freedom of mobile multimedia access (FOMA) and time division-synchronous code division multiple access (TD-SCDMA).

The mobile telecommunications network 510 may be operatively connected to a wide-area network 520, which may be the Internet or a part thereof. An Internet server 522 has data storage 524 and is connected to the wide area network 520. The server 522 may host a worldwide web/wireless application protocol server capable of serving worldwide web/wireless application protocol content to the mobile terminal 500. The mobile terminal 500 can also be coupled to the Internet 520. In one embodiment, the mobile terminal 500 can be coupled to the Internet 520 via a wired or wireless link, such as a Universal Serial Bus (USB) or Bluetooth™ connection, for example.

A public switched telephone network (PSTN) 530 may be connected to the mobile telecommunications network 510 in a familiar manner. Various telephone terminals, including the stationary telephone 532, may be connected to the public switched telephone network 530.

The mobile terminal 500 is also capable of communicating locally via a local link 501 to one or more local devices 503. The local links 501 may be any suitable type of link or piconet with a limited range, such as for example Bluetooth™, a USB link, a wireless Universal Serial Bus (WUSB) link, an IEEE 802.11 wireless local area network (WLAN) link, an RS-232 serial link, etc. The local devices 503 can, for example, be various sensors that can communicate measurement values or other signals to the mobile terminal 500 over the local link 501. The above examples are not intended to be limiting, and any suitable type of link or short range communication protocol may be utilized. The local devices 503 may be antennas and supporting equipment forming a wireless local area network implementing Worldwide Interoperability for Microwave Access (WiMAX, IEEE 802.16), WiFi (IEEE 802.11x) or other communication protocols. The wireless local area network may be connected to the Internet. The mobile terminal 500 may thus have multi-radio capability for connecting wirelessly using mobile communications network 510, wireless local area network or both. Communication with the mobile telecommunications network 510 may also be implemented using WiFi, Worldwide Interoperability for Microwave Access, or any other suitable protocols, and such communication may utilize unlicensed portions of the radio spectrum (e.g. unlicensed mobile access (UMA)). In one embodiment, the process modules 122 of FIG. 1 include communication module 134 that is configured to interact with, and communicate with, the system described with respect to FIG. 5.

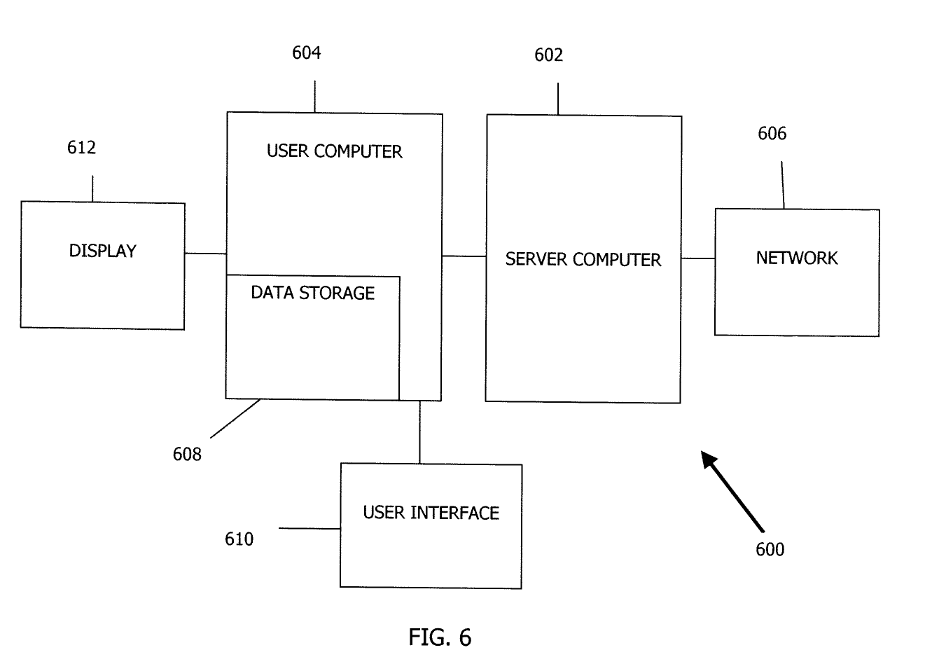

The disclosed embodiments may also include software and computer programs incorporating the process steps and instructions described above. In one embodiment, the programs incorporating the process steps described herein can be stored on or in a computer program product and executed in one or more computers. FIG. 6 is a block diagram of one embodiment of a typical apparatus 600 incorporating features that may be used to practice aspects of the invention. The apparatus 600 can include computer readable program code means embodied or stored on a computer readable storage medium for carrying out and executing the process steps described herein. In one embodiment the computer readable program code is stored in a memory(s) of the device. In alternate embodiments the computer readable program code can be stored in memory or other storage medium that is external to, or remote from, the apparatus 600. The memory can be direct coupled or wireless coupled to the apparatus 600. As shown, a computer system 602 may be linked to another computer system 604, such that the computers 602 and 604 are capable of sending information to each other and receiving information from each other. In one embodiment, computer system 602 could include a server computer adapted to communicate with a network 606. Alternatively, where only one computer system is used, such as computer 604, computer 604 will be configured to communicate with and interact with the network 606. Computer systems 602 and 604 can be linked together in any conventional manner including, for example, a modem, wireless, hard wire connection, or fiber optic link. Generally, information can be made available to both computer systems 602 and 604 using a communication protocol typically sent over a communication channel or other suitable connection or line, communication channel or link. In one embodiment, the communication channel comprises a suitable broad-band communication channel. Computers 602 and 604 are generally adapted to utilize program storage devices embodying machine-readable program source code, which is configured to cause the computers 602 and 604 to perform the method steps and processes disclosed herein. The program storage devices incorporating aspects of the disclosed embodiments may be devised, made and used as a component of a machine utilizing optics, magnetic properties and/or electronics to perform the procedures and methods disclosed herein. In alternate embodiments, the program storage devices may include magnetic media, such as a diskette, disk, memory stick or computer hard drive, which is readable and executable by a computer. In other alternate embodiments, the program storage devices could include optical disks, read-only-memory (“ROM”) floppy disks and semiconductor materials and chips.

Computer systems 602 and 604 may also include a microprocessor(s) for executing stored programs. Computer 602 may include a data storage device 608 on its program storage device for the storage of information and data. The computer program or software incorporating the processes and method steps incorporating aspects of the disclosed embodiments may be stored in one or more computers 602 and 604 on an otherwise conventional program storage device. In one embodiment, computers 602 and 604 may include a user interface 610, and/or a display interface 612 from which aspects of the invention can be accessed. The user interface 610 and the display interface 612, which in one embodiment can comprise a single interface, can be adapted to allow the input of queries and commands to the system, as well as present the results of the commands and queries, as described with reference to FIG. 1, for example.

The aspects of the disclosed embodiments provide for transitioning from rapid navigation of a document to fine positioning, using a scrollbar navigation device. This can be accomplished by configuring the thumb of the scrollbar to be dragged or moved away from the axis line of the scrollbar track. The degree of deflection of the thumb from the axis line or path of the scrollbar track can be determined, and a scaling factor calculated that corresponds to the degree of deflection, or distance. This scaling factor can be applied to the scrollbar, which then slows the scrolling for fine positioning. When the deflected thumb is released, the thumb can snap or revert back to its original position, with the scrolling returning to the original scaling factor.

It is noted that the embodiments described herein can be used individually or in any combination thereof. It should be understood that the foregoing description is only illustrative of the embodiments. Various alternatives and modifications can be devised by those skilled in the art without departing from the embodiments. Accordingly, the present embodiments are intended to embrace all such alternatives, modifications and variances that fall within the scope of the appended claims.

What is claimed is:

1. A method comprising:
providing a display window with a perimeter;
displaying a set of data in a display area of the display window, the set of data having zero or more elements;
providing at least one scroll region on the display;
wherein movement of a pointing device in the at least one scroll region causes the set of data in the display area to be scrolled in a corresponding direction according to a scroll increment; and
responsive to a repositioning of the pointing device in a manner that deflects the pointing device away from an axis path of the scroll region, increasing an available scrolling distance in the display window.

2. The method of claim 1 further comprising that the scroll region is a predefined touch sensitive area on the display.

3. The method of claim 2 further wherein the axis path is an approximate straight line of the scroll region extending from one side of the pre-defined touch sensitive area to an other side of the touch sensitive area corresponding to an initial contact point of the pointing device.

4. The method of claim 3 wherein the pre-defined touch sensitive area comprises an entirety of the display area.

5. The method of claim 1 further comprising that the scroll region is not visible on the display.

6. The method of claim 1 further comprising that the repositioning of the pointing device in a manner that moves the pointing away from the axis path within the scroll region increases a granularity at which the set of data is scrolled.

7. The method of claim 1 wherein the repositioning of the pointing device is a movement of the pointing device away from the axis path within the scroll region, wherein a distance of the movement away from the axis path redefines a scaling of the scroll increment.

8. The method of claim 1 wherein the wherein a small deflection of the pointing device away from the axis path within the scroll region corresponds to a minimal refinement in the scaling of the scroll increment and a large deflection of the pointing device away from the axis path within the scroll region corresponds to a greater refinement in the scaling of the scroll increment.

9. The method of claim 1 further comprising detecting a release of the pointing device from the touch sensitive area while the pointing device is in the deflected position, and automatically resetting the scale increment to an original value.

10. The method of claim 1 further comprising:
determining a distance corresponding to the movement of the pointing device from the axis path;
determining a scaling factor corresponding to the determined distance; and
changing the scale increment for the scrolling based on the determined scaling factor.

11. The method of claim 10 wherein a greater determined distance corresponds to a reduced scale increment.

12. The method of claim 11 wherein the reduced scale increment slows the scrolling for fine position of the set of data on the display.

13. The method of claim 1 wherein the set of data is a document or a web page.

14. The method of claim 1 wherein the display window and scroll region are implemented on a mobile communication device.

15. The method of claim 1 wherein the scroll region comprises a scrollbar, the scrollbar having a first end and a second end, the axis path being defined between the first end and the second end and a thumb device initially positioned on the axis path between the first end and the second end, and wherein the pointing device is configured to move the thumb along the axis path to causes the set of data to be scrolled in the corresponding direction.

16. The method of claim 15 wherein the pointing device is configured to move the thumb in a manner that deflects the thumb away from the axis path to increase a granularity of the scroll increment.

17. An apparatus comprising:
a display having a display area;
at least one processor configured to providing a display window with a perimeter in the display area; the at least one processor being further configured to:
display a set of data in a display area of the display window;
providing at least one scroll area along at least a portion of the display window, the scroll area having a an axis path defined therebetween along an approximate straight line defined from an initial contact point of a pointing device with the scroll area;
detect movement of the pointing device along the axis path and cause the set of data in the display area to be scrolled in a corresponding direction according to a scroll increment;
detect a movement of the pointing device away from the axis path; and
increase an available scrolling area in the display window.

18. The apparatus of claim 17, wherein the at least one processor is further configured to:
determine a distance corresponding to the movement of the pointing device away from the axis path;
determine a scaling factor corresponding to the determined distance; and
change the scale increment for the scrolling based on the determined scaling factor.

19. The apparatus of claim 17 wherein increasing the available scrolling area comprises reducing a granularity of the scroll increment.

20. The apparatus of claim 19 wherein the reduced scale increment slows the scrolling for fine positioning of the set of data on the display.

21. A computer program product comprising a computer readable storage medium configured to execute the method according to claim 1 when implemented on a device including at least one processor.
